(19) United States
(12) Patent Application Publication
(10) Pub. No.: US 2026/0018879 A1
(43) Pub. Date: Jan. 15, 2026

(54) POWER CONVERTER CONTROL METHOD

(71) Applicant: NAGASAKI INSTITUTE OF APPLIED SCIENCE, Nagasaki (JP)

(72) Inventor: Fujio KUROKAWA, Nagasaki (JP)

(21) Appl. No.: 19/338,001

(22) Filed: Sep. 24, 2025

Related U.S. Application Data
(63) Continuation of application No. PCT/JP2024/010761, filed on Mar. 19, 2024.

(30) Foreign Application Priority Data
Mar. 27, 2023 (JP) 2023-049776

(51) Int. Cl. H02H 7/12; H02M 1/00; H02M 3/335

(52) U.S. Cl. CPC H02H 7/1213; H02M 1/0048; H02M 1/0074; H02M 3/33571

(57) ABSTRACT

Provided is a power converter control method short-circuits, with use of a switching device that has a switch and that is connected to power converters in series or in parallel, an arbitrary one of the power converters. The power converter control method includes placing the switching device in an ON state by continuously increasing ON-time of the switch.

### CROSS-REFERENCE TO RELATED APPLICATIONS

This application is a Continuation Application of PCT International Application No. PCT/JP2024/010761, filed on Mar. 19, 2024, which is based upon and claims the benefit of priority from Japanese Patent Application No. 2023-049776, filed on Mar. 27, 2023, the disclosure of which is hereby incorporated by reference herein in their entireties.

### TECHNICAL FIELD

The present invention relates to a power converter control method that disconnects and restores an arbitrary power converter out of a plurality of power converters (converters) connected in series with use of a switching device that is connected to the power converter in series or in parallel.

### BACKGROUND ART

Hitherto, in a power grid that supplies power to equipment from a power plant, a solar cell, and the like that are remotely placed, a bus stabilization power converter (for example, a DC-DC converter for stabilizing a DC bus) is disposed in order to stabilize the supplied power (DC bus). However, in this case, the number of power converters in the power grid increases. Therefore, there has been a problem in that power loss occurs, only from about 40% to about 50% of the total power generation amount can be sent to equipment on a distal end of the power grid, and only about 60% of the total power generation amount can be sent even when a high-performance power converter is used.

Here, as technologies for reducing power loss, there have been technologies described in Patent Literatures 1 and 2.

In Patent Literature 1, a DC-AC conversion power converter aimed to reduce power conversion loss due to switching and efficiently process reactive power is described. In a first switching circuit 1 used as a DC-DC converter, this power converter performs high-speed switching operation for generating a DC pulse voltage signal. In a second switching circuit 4 used as a DC-AC converter, this power converter performs switching at a frequency of an AC sinusoidal signal while synchronizing with a first switching circuit S1 (see FIG. 1).

Meanwhile, in Patent Literature 2, an invention relating to a solar cell module having a power converter is described. This invention particularly aims to reduce the power loss in the power converter by controlling the temperature of a core of an isolation transformer of the power converter.

### CITATION LIST

### Patent Literature

Patent Literature 1: Japanese Patent Laid-Open No. 2009-095120

Patent Literature 2: Japanese Patent Laid-Open No. 2005-150569

### SUMMARY OF INVENTION

### Technical Problem

In the power grid, it is always required to use a power conversion technology with better efficiency without changing the configuration of an existing power converter. In particular, it is required to stabilize the voltage across the DC bus as much as possible in actual operation such that stabilization is prioritized even when the voltage across the DC bus becomes extremely high or low.

Therefore, an object of the present invention is to provide a power converter control method capable of enabling an entire DC bus to be efficiently and stably operated while handling fluctuations in voltage such as voltage across the DC bus becoming extremely high or low.

### Solution to Problem

A power converter control method of the present invention short-circuits, with use of a switching device that has a switch and that is connected to power converters in series or in parallel, an arbitrary one of the power converters. The power converter control method includes placing the switching device in an ON state by continuously increasing ON-time of the switch.

The power converter control method of the present invention short-circuits, with use of a switching device that has a switch and that is connected to a power converter in series or in parallel, an arbitrary one of the power converters. The power converter control method includes handling the switch as a resistor that is continuously changed by continuously changing voltage driving or current driving of the switch, and obtaining a short-circuit by gradually reducing a resistor value of the switching device handled as the resistor.

The power converter control method of the present invention short-circuits, with use of a switching device that has a switch and that is connected to a power converter in series or in parallel, an arbitrary one of the power converters. The power converter control method places the switching device in an ON state by gradually causing the switch to approach the ON state by influence of any of a resistor, a capacitor, and an inductor while instantaneously turning ON the switch.

The power converter control method of the present invention is a power converter control method of short-circuiting, with use of a switching device that has a switch and that is connected to a power converter in series or in parallel, an arbitrary one of the power converters. The power converter control method includes reducing, out of a plurality of the power converters, ON-time of an arbitrary power converter to reduce input voltage across another power converter, and subsequently placing the switching device connected to the arbitrary power converter in an ON state at a time point at which the input voltage across the other power converter is reduced to a certain value or a time point at which the input voltage across the arbitrary power converter rises to a certain value.

The switching device is preferably connected to an input capacitor of the arbitrary power converter to be short-circuited in parallel.

Alternatively, the switching device is preferably connected to each of the plurality of power converters connected in series, and an arbitrary one of the power converters is preferably short-circuited so as to divide the plurality of power converters into a power converter that is operated and a power converter that is not operated based on a threshold value provided in accordance with the number of the plurality of power converters.

### Advantageous Effects of Invention

In the power converter control method of the present invention, a so-called circuit on the input side is placed in a short-circuited state when switching device connected to the power converter in series or in parallel is placed in an ON state. In other words, the input voltage across the power converter to which the switching device is connected becomes zero. Therefore, even when the input voltage across the serial bus decreases or one power converter configuring the serial bus fails due to short-circuit, the entire DC bus can be stably operated because the other power converters are operating.

In the configuration described above, as long as the switching device has a configuration including a resistor, a peak value of inrush current from the input capacitor can be suppressed by using a resistor having a large resistance value as the resistor.

### BRIEF DESCRIPTION OF DRAWINGS

FIG. 1 is a diagram for describing the configuration of a circuit controlled by a power converter control method according to an embodiment of the present invention.

FIG. 2(A), FIG. 2(B), and

FIG. 2(C) are diagrams showing examples of the power converter controlled by the power converter control method according to the embodiment of the present invention in which FIG. 2(A) is a full-bridge converter,

FIG. 2(B) is a half-bridge converter, and FIG. 2(C) is a buck-boost converter.

FIG. 3(A) and FIG. 3(B) are diagrams for describing the power converter control method according to the embodiment of the present invention.

FIG. 4(A) and FIG. 4(B) are diagrams for describing the power converter control method according to the embodiment of the present invention.

FIG. 5(A), FIG. 5(B), and FIG. 5(C) are diagrams showing connection examples of a switching device and showing examples in which the switching device is connected to the capacitor in series.

FIG. 6 is a diagram showing a four-series converter used in a simulation.

FIG. 7 is a diagram showing a simulation result.

FIG. 8 is a diagram showing a simulation result.

FIG. 9 is a diagram showing a simulation result.

FIG. 10 is a diagram showing a simulation result.

FIG. 11 is a diagram for describing an operation example of a power converter control method of the present invention.

### DESCRIPTION OF EMBODIMENT

An embodiment of the present invention is described in detail below. The description of a configuration described below is one example (representative example) of the embodiment of the present invention, and the present invention is not limited to the content below as long as the gist thereof is not changed.

### Configuration of Circuit

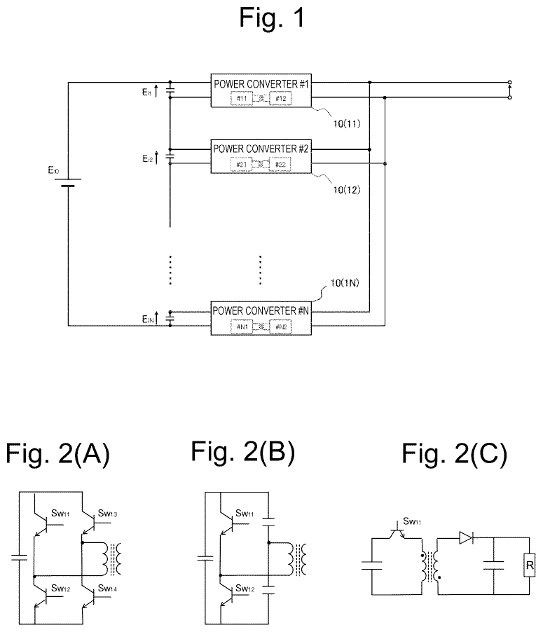

A power converter control method of the present invention may handle a power converter in which input voltage across a DC bus fluctuates as shown in FIG. 1. In the configuration shown in FIG. 1, a plurality of power converters 10 (11 to 1N) are connected in series on the input side. Each of the power converters 10 can be a DC-DC converter, a DC-AC converter, or a bidirectional power converter (for example, a DAB converter (isolated bidirectional power converter), or the like.

In a circuit configuration as above, when input voltage Eᵢ₀ across a serial bus decreases or one power converter 10 fails due to short-circuit, the entire circuit is placed in an unstable state.

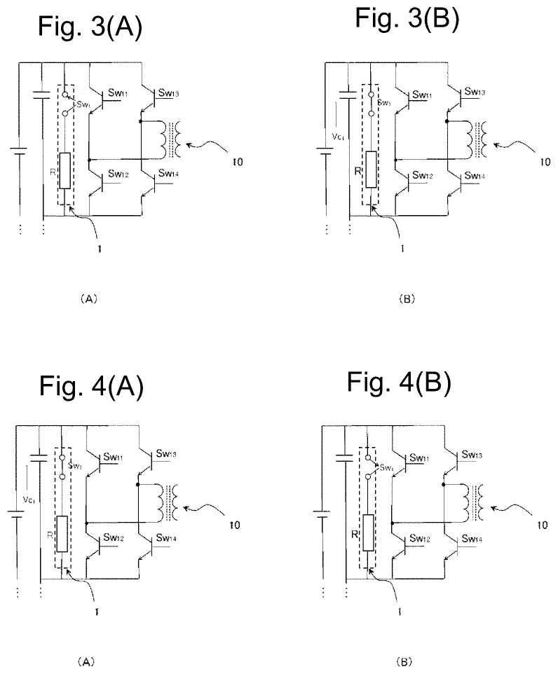

Therefore, the power converter control method of the present invention is a control method for enabling the entire circuit to efficiently or stably operate with use of a switching device 1 (see FIGS. 3(A) and 3(B)) connected to an arbitrary power converter 10 in series or in parallel.

As shown in FIGS. 2(A), 2(B), and 2(C), the power converter to be controlled is not particularly limited and is a full-bridge converter, a half-bridge converter, a buck-boost converter, or the like. For example, the full-bridge converter shown in FIG. 2(A) is configured with use of a plurality of switching elements Sw₁₁, Sw₁₂, Sw₁₃, Sw₁₄. Those switching elements Sw₁₁ to Sw₁₄ control the conversion of input power by performing switching operation.

### Power Converter Control Method

The power converter control method of the present invention is described below with reference to FIGS. 3 and 4. An example of a full-bridge converter (see FIG. 2(A)) is described as a circuit to be controlled.

First, as shown in FIG. 3(A), the switching device 1 is connected to the power converter 10. As shown in FIG. 3(A), the switching device 1 is configured by a switch (semiconductor switch) Sw₁ and a resistor R connected in series.

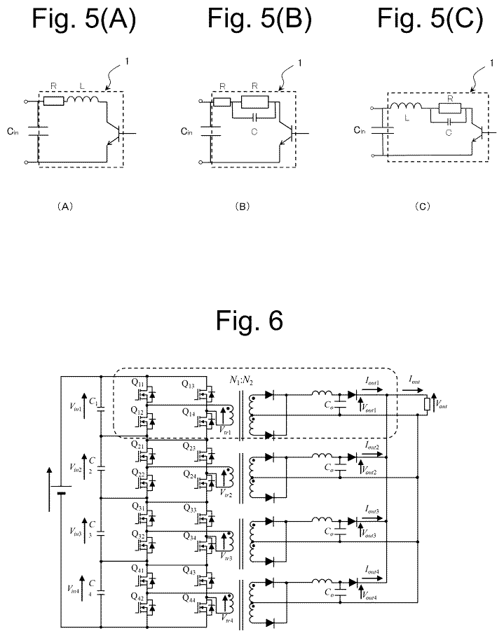

As shown in FIGS. 5(A), 5(B), and 5(C), the switching device 1 may have a configuration including an inductor L (see FIG. 5(A)), a configuration in which the resistor R and a capacitor C are connected in parallel (see FIG. 5(B)), or a configuration obtained by combining those configurations (see FIG. 5(C)).

For example, in the case of the configuration shown in FIG. 5(A), a transistor can be considered as a switch and can be operated as the switch Sw₁ shown in FIGS. 3 and 4. Here, a bipolar transistor, a unipolar transistor, a MOSFET, an IGBT, and the like can be used, for example, as the transistor that configures the switching device 1.

As shown in FIG. 3(A), first, the switch Sw₁ is turned ON.

Subsequently or at the same time as the switch Sw₁ is turned ON, all of the switching elements Sw₁ to Sw₁₄ of the power converter 10 are opened (turned OFF) as shown in FIG. 3(B). As a result, energy of the capacitor is consumed by the resistor R of the switching device 1 connected to the capacitor in parallel. At this time, current (in particular, push current) does not flow through the switching elements Sw₁₁ to Sw₁₄, and hence there is no fear that the switching elements Sw₁₁ to Sw₁₄ may get broken.

The timings at which the switch Sw₁ and the switching elements Sw₁₁ to Sw₁₄ are turned ON and turned OFF are not limited to the above as long as the push current may be prevented by those timings.

In the control method of the present invention, in order to continuously change and not instantaneously change ON and OFF of voltage driving or current driving by the switch Sw₁, the switch Sw₁ is used as a resistor that continuously changes instead of a switch element. A resistor value of the switching device used as the resistor is gradually reduced and is eventually short-circuited. In the example shown in FIGS. 3 and 4, the switching device 1 has a configuration including the resistor R but may have a configuration only having the switch Sw₁ (without the resistor R).

A procedure of obtaining a short-circuit by continuously increasing the ON-time of the switch Sw₁ in a gradual manner and eventually obtaining a completely ON state may be employed.

Alternatively, a short-circuit may be obtained by instantaneously turning ON the switch Sw1, gradually approaching the ON state by the influence of the resistor R, the capacitor C, and the inductor L, and eventually obtaining a complete ON state.

A short-circuit may be obtained by changing the voltage driving or the current driving of a drive signal such that a resistance component changes in addition to the switching elements Sw₁₁ to Sw₁₄ of the power converter 10 being turned ON and OFF as switches. For example, a Field-Effect Transistor (EFT) is driven by voltage and a transistor is driven by current, and hence a configuration without a resistor and with only switches can be employed.

Next, a procedure of recovering a disconnected power converter is described.

First, the switch Sw₁ of the switching device 1 is in an ON state, and voltage V_{c1} across the capacitor is almost zero. In this state, all of the switching elements Sw₁₁ to Sw₁₄ shown in FIG. 4(A) are turned ON.

Then, as shown in FIG. 4(B), the switch Sw₁ is turned OFF. Next, the switching elements Sw₁₁ to Sw₁₄ are driven by a predetermined control signal, and recovery to a normal operation of converting input power is made.

By performing such disconnection/recovery control, the circuit of an arbitrary power converter is short-circuited while the other power converters are operated as is. As a result, the entire circuit can be efficiently or stably operated.

As another procedure of short-circuiting the switching device 1 (placing in an ON state), a procedure shown below may be employed. Here, a power converter to which the switching device 1 to be short-circuited is connected is referred to as a “disconnecting power converter”.

(1) Out of a plurality of power converters, the ON-time of the disconnecting power converter is reduced. As a result, the input voltage across the other power converters is reduced.
(2) Then, at the time point at which the input voltage across the other power converters has decreased to a certain value or at the time point at which input voltage across the disconnecting power converter has risen to a certain value, the switching device connected to the disconnecting power converter is placed in an ON state.

By following such a procedure, the input voltage across the disconnecting power converter is raised to a certain value, and hence a peak value of the push current from the input capacitor can be suppressed.

### Simulation

A simulation of a feedback control by the power converter control method of the present invention has been performed for a four-series converter shown in FIG. 6. A circuit is designed as below, and circuit parameters are those shown in Table 1.

When the electric capacity of a single power converter at the time of maximum output is 1.5 kW,
Load current I_{OUT} when the load is 100%: 31.25 A.
Load current I_{OUT} when the load is 50%: 15.625 A.
Load current I_{OUT} when the load is 10%: 3.125 A

When four power converters are operated,
Secondary-side reactor L: 61.9 uH
Input voltage Vᵢₙ: 375 V
Output voltage V_{OUT}: 48 V
Duty ratio D: 0.31
Transformer turns ratio N1/N2: 22/9
Switching frequency fₛ: 80 KHz
Switching period Tₛ: 12.5 us
Critical current Ic: 1.65 A (from Expression (1) below) When three power converters are operated,
Input voltage Vᵢₙ: 500 V
Duty ratio D: 0.23
Critical current Ic: 1.82 A (from Expression (1) below).
Parameters other than those described above are the same as the time when four power converters are operated

$$\begin{matrix}[ Expression 1 ] & \\ {I}_{C} = \frac{{DT}_{S}}{4 L} ( {V}_{i n} \frac{N 2}{N 1} - {V}_{out} ) & ( 1 )\end{matrix}$$

TABLE 1

| Parameter | Value | |
|---|---|---|
| Input voltage Vin | From 300 V to 500 V | |
| Output voltage Vout | 48 | V |
| Output current Iout | 31.25 | A |
| Switching frequency fs | 80 | kHz |
| Input capacitor Ci | 0.68 | uF × 2 |
| Output capacitor Co | 680 | uF × 4 |
| Secondary-side reactor Lo | 61.9 | uH |
| Transformer turns ratio N1:N2 | 22:9:9 | |
| Excitation inductance Lp | 4.69 | mH |
| Line inductance | 8 | nH |
| Stray capacitance | 61 | pF |

| | |
|---|---|
| Input voltage Vin | From 300 V to 500 V |

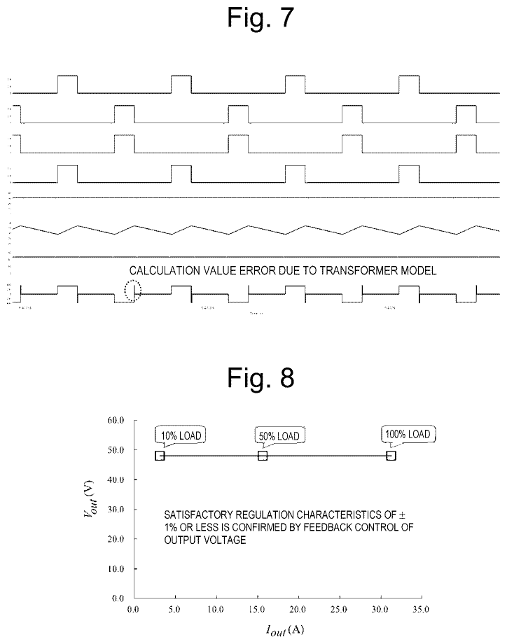

When the input voltage Vin decreases, all of the switches of the power converter indicated by a dashed frame are turned ON and are disconnected. The simulation results are shown in FIGS. 7 to 10.

FIG. 7 is an operating waveform when four power converters are operated (the load is 100%, the input voltage Vᵢₙ: 375 V, the output voltage V_{OUT}: 48 V, the load current I_{OUT}: 31.25 A). Meanwhile, FIG. 8 is a graph showing regulation characteristics.

As shown in FIG. 7, there is a calculation value error (see a dashed frame) due to a transformer model, but it can be understood that there are no problems in each operating waveform and that the output voltage is able to be controlled to be the same value (48 V) as the target value by the feedback control.

As shown in FIG. 8, satisfactory regulation characteristics in which the output voltage is equal to or less than the target value (48 V)±1% has been able to be confirmed by the feedback control of the output voltage at each of the time when the load is 10%, the time when the load is 50%, and the time when the load is 100%.

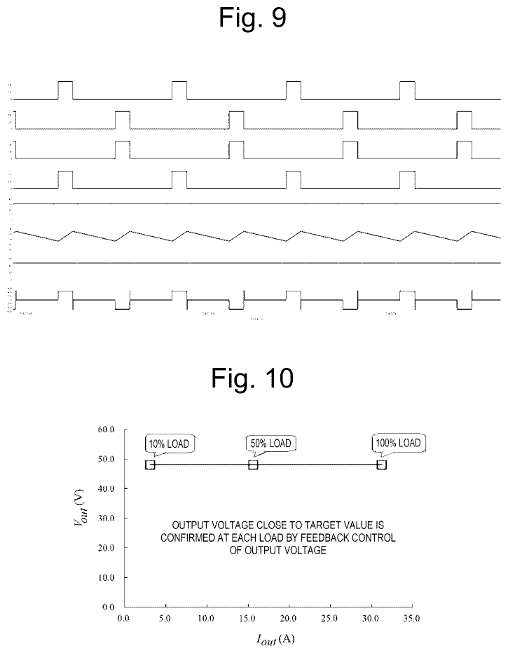

FIG. 9 is an operating waveform when three power converters are operated (the load is 100%, the input voltage Vin: 500 V, the output voltage V_{OUT}: 48 V, the load current I_{OUT}: 31.25 A). Meanwhile, FIG. 10 is a graph showing regulation characteristics.

As shown in FIG. 9, as with the operation with four power converters, it can be understood that there are no problems in each operating waveform and that the output voltage is able to be controlled to be the same value (48 V) as the target value by the feedback control.

As shown in FIG. 10, output voltage close to the target value (48 V) has been able to be confirmed by the feedback control of the output voltage at each of the time when the load is 10%, the time when the load is 50%, and the time when the load is 100% here as well.

### Threshold Value

The switching device 1 can be connected to each of a plurality of power converters, and an arbitrary one of the power converters can be short-circuited so as to divide the plurality of power converters into a power converter that is operated and a power converter that is not operated based on a threshold value provided in accordance with the number of the plurality of power converters.

For example, in a case of a DC bus configured by four bidirectional converters (the operatable range of one bidirectional converter: from 200 V to 400 V),

(1) From 200 V to 300 V: Operation is performed with one bidirectional converter.
(2) From 300 V to 400 V: Operation is performed with one bidirectional converter, and the bidirectional converter is operated and a battery charge and discharge operation is performed in order to stabilize the DC bus.
(3) From 400 V to 500 V: Operation is performed with two bidirectional converters, and the bidirectional converters are operated and a battery charge and discharge operation is performed in order to stabilize the DC bus.
(4) From 500 V to 650 V: Operation is performed with two bidirectional converters.
(5) From 650 V to 750 V: Operation is performed with two or three bidirectional converters, and the bidirectional converters are operated and a battery charge and discharge operation is performed in order to stabilize the DC bus.

For example, when the voltage rises, a hysteresis operation with two bidirectional converters is performed to the point of 750 V. Meanwhile, when the voltage decreases, a hysteresis operation with three bidirectional converters is performed to the point of 650 V.

(6) From 750 V to 900 V: Operation is performed with three bidirectional converters.
(7) From 900 V to 1000 V: Operation is performed with three or four bidirectional converters, and the bidirectional converters are operated and a battery charge and discharge operation is performed in order to stabilize the DC bus.

For example, when the voltage rises, a hysteresis operation with three bidirectional converters is performed to the point of 1000 V. Meanwhile, when the voltage decreases, a hysteresis operation with four bidirectional converters is performed to the point of 900 V.

(8) From 1000 V to 1600 V: Operation is performed with four bidirectional converters.

Needless to say, each example of the threshold values described above is one example, and the threshold values can be set, as appropriate, in accordance with the number of the power converters and the like.

### Operation Example

An operation example of the present invention is described below. The power converter control method of the present invention can be used in an N-series-input N-parallel-output power converter.

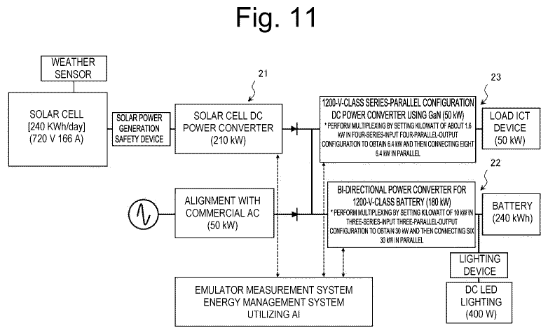

One example is a configuration of a power converter 21 that converts power from a solar cell to 1200 V and 1500 V, a bi-directional DC power converter 22 having a three-series-input three-parallel-output configuration for charging and discharging a battery, and a power converter 23 having a four-series-input four-parallel-output configuration as that shown in FIG. 11.

The following case is conceived as an operation form in which bus voltage is dropped in such a configuration.

(When Power Generation Amount from Solar Cell is Almost Zero)

Specifically, the case is when the power generation amount from the solar cell becomes almost zero and the remaining capacity of the battery is low such as when rainy weather continues or when disaster occurs, for example. Precious power that is not much left is used only in (narrowed down to) important work, and hence the load power of the four-series-input four-parallel-output converter that supplies power to the load is reduced. Therefore, by reducing the number of parallel output on the output side, the decrease in power conversion efficiency can be suppressed.

For example, in switching converters, the efficiency extremely decreases when the load is light. Therefore, by performing operation while reducing the number of parallel operations, the load factor of the converters that are in operation is increased. As a result, the efficiency can be improved.

In addition, the power discharged from the battery also decreases. Therefore, the number that is in parallel on the battery side of the three-series-input three-parallel-output bi-directional DC power converter is reduced and the efficiency is maintained. In accordance with the above, the number in series on the bus side also decreases, and hence it becomes possible to handle the bus voltage that has dropped.

When the battery remaining amount is sufficient, the bus voltage does not necessarily need to be dropped.

As above, the bi-directional DC power converter of the battery, the four-series-input four-parallel-output DC power converter on the load side, and a converter called a conditioner of energy sources such as a solar cell and a wind power generator (not shown here) can have a similar series-parallel configuration. Therefore, when the above cooperatively operate, a system that may improve the efficiency when the power is low is obtained. The above may be obtained by parallelly connecting converters that are in series.

(When Extraction is Desired to be Performed until Voltage across Battery Drops)

Even when the voltage across battery decreases, it is possible to raise the voltage to the bus voltage by the bi-directional DC power converter, but the efficiency decreases. Thus, high efficiency is maintained by keeping the time ratio (the ratio between the ON-time and the OFF-time) of the bi-directional DC power converter as is. As a result, the drop of the bus voltage is intentionally tolerated.

However, at this time, power is not supplied from the solar cell, such a situation is caused as a result thereof, and the power converter of the solar cell is not operated. Therefore, it is desired that the number of operations in series be changed in accordance with the bus voltage in the four-series-input four-parallel-output DC power converter that supplies power to the load.

A server power source is normally operated with a load factor of about 20% to about 30%. Therefore, even when the number of operations is reduced to half, no problem occurs in the operation.

(When Baseload Power Supply such as Commercial AC Grid is Lost)

When a baseload power supply such as a commercial AC grid is lost, the load is operated by power from the solar cell and power from the battery. However, when the operation of the load is narrowed down, the same operation as that in the case where the power generation amount from the solar cell is almost zero described above is performed.

When the power from the solar cell is desired to be used, the bus voltage as the output of the power converter of the solar cell drops. Therefore, it is desired that the output side (bus voltage side) be enabled to handle the change in voltage by a series configuration in the power converter of the solar cell.

Application examples of an operation form as above include a server power source such as a large-scale data center, or a power source for a large-capacity centralized air conditioner used in buildings such as data centers and airports, constructions, and the like.

### INDUSTRIAL APPLICABILITY

The power converter control method according to the present invention can be used in various power transmission facilities and the like such as power grids from remote power plants and solar cells as a power converter control method that enables an entire DC bus to operate efficiently and stably, and hence is industrially useful.

### REFERENCE SIGNS LIST

1 switching device
10, 11, 12, 1N power converter

1. A power converter control method of short-circuiting, with use of a switching device that has a switch and that is connected to power converters in series or in parallel, an arbitrary one of the power converters, the power converter control method comprising:
placing the switching device in an ON state by continuously increasing ON-time of the switch.

2. A power converter control method of short-circuiting, with use of a switching device that has a switch and that is connected to power converter in series or in parallel, an arbitrary one of the power converters, the power converter control method comprising:
handling the switch as a resistor that is continuously changed by continuously changing voltage driving or current driving of the switch, and obtaining a short-circuit by gradually reducing a resistor value of the switching device handled as the resistor.

3. A power converter control method of short-circuiting, with use of a switching device that has a switch and one or more of a resistor, a capacitor, and an inductor and that is connected to power converters in series or in parallel, an arbitrary one of the power converters, the power converter control method comprising:
placing the switching device in an ON state by instantaneously turning ON the switch and gradually causing the switch to approach the ON state by influence of any of the resistor, the capacitor, and the inductor.

4. A power converter control method of short-circuiting, with use of a switching device that has a switch and that is connected to power converters in series or in parallel, an arbitrary one of the power converters, the power converter control method comprising:
reducing ON-time of an arbitrary power converter out of the plurality of power converters to reduce input voltage across another power converter; and
subsequently placing the switching device connected to the arbitrary power converter in an ON state at a time point at which the input voltage across the another power converter is reduced to a certain value or a time point at which the input voltage across the arbitrary power converter rises to a certain value.

5. The power converter control method according to claim 1, wherein the switching device is connected to an input capacitor of the arbitrary power converter to be short-circuited in parallel.

6. The power converter control method according to claim 1, wherein:
the switching device is connected to each of a plurality of power converters connected in series; and
an arbitrary one of the plurality of power converters is short-circuited so as to divide the plurality of power converters into a power converter that is operated and a power converter that is not operated based on a threshold value provided in accordance with a number of the plurality of power converters.
